(19) United States
(12) Patent Application Publication
(10) Pub. No.: US 2023/0017163 A1
(43) Pub. Date: Jan. 19, 2023

(54) METHOD FOR DEGASSING A FLUID

(71) Applicants: UNIVERSITE GRENOBLE ALPES, Saint Martin D'Heres (FR); CENTRE NATIONAL DE LA RECHERCHE SCIENTIFIQUE, Paris (FR); INSTITUT POLYTECHNIQUE DE GRENOBLE, Grenoble (FR)

(72) Inventors: Damien COLOMBET, Villard-Bonnot (FR); Frédéric AYELA, Chambery (FR)

(21) Appl. No.: 17/785,877

(22) PCT Filed: Dec. 16, 2020
(86) PCT No.: PCT/EP2020/086451

§ 371 Date: Jun. 15, 2022

(30) Foreign Application Priority Data
Dec. 17, 2019 (FR) 1914650

(51) Int. Cl. B01D 19/00

(52) U.S. Cl. CPC B01D 19/0094; B01D 19/0042; B01D 2259/816

(57) ABSTRACT

The invention relates to a method for degassing a fluid comprising the following steps: supplying, at the inlet of a reactor comprising at least one microfluidic conduit, a fluid which can comprise at least one dissolved gas; then causing the fluid to flow through the reactor, the at least one conduit comprising a portion having a reduced hydraulic diameter, and the flow being set such that bubbles are generated by micro-cavitation, the fluid then comprising a liquid phase and a gas phase, then allowing the at least partial transfer of the at least one dissolved gas present in the fluid of the liquid phase to the gas phase; separating the liquid phase and the gas phase; and recovering the liquid phase to obtain the degassed fluid, the method not involving the application of ultrasound to the fluid between the step in which the fluid is supplied to the reactor and the step of separating the liquid phase and the gas phase.

### TECHNICAL FIELD

This invention relates to the field of the methods for degassing a fluid, and more particularly the field of the methods for degassing a fluid by cavitation. It finds a particularly advantageous application for the extraction of gases dissolved in the fluid, and more particularly a liquid.

### STATE OF THE ART

The at least partial extraction of dissolved gases in a fluid, also called degassing, is a common practice, first in order to prevent these gases from reacting with other dissolved compounds in the fluid. For example, dissolved dioxygen can be extracted from a solvent when other compounds intended to be dissolved in this solvent are sensitive to dioxygen. The dissolved gases can further be extracted from a fluid, upstream of certain technological steps of fluid treatment, in order to avoid the formation of bubbles which can be problematic during these technological steps. For example, the formation of gas bubbles when a fluid is solidified can be undesirable.

There are several solutions to degas a fluid. First, the degassing of a fluid can be carried out thanks to the use of a liquid-phase chemical reaction. In the food industry, the elimination of dissolved dioxygen in wine by chemical reaction with sulphite salts can be mentioned as an example. However, this method implies the addition of chemical reagents in the fluid to be degassed.

It is also possible to degas one liquid by substitution with another gas. However, this method is more similar to a replacement of the dissolved gases than a degassing.

Several degassing methods aim at performing a transfer of the gases dissolved in a liquid phase to a gas phase, the liquid phase capable of being separated from the gas phase to obtain the degassed fluid. Such a transfer is linked to a phenomenon which can be modelled by Henrys law. More particularly, the solubility of a gas can obey Henrys law, that is to say that the equilibrium between the amount of dissolved gas in the liquid phase and the amount of gas in the gas phase, in contact with the liquid phase, is controlled by the following relation, for a given gas:

$$\frac{{x}_{g}}{{x}_{l}} = \frac{H}{P}$$

With x_{g} the molar fraction of gases in the gas phase, xₗ The molar fraction of dissolved gases in the liquid phase, H the Henry's constant of the considered gas, in PA, and P the pressure in the gas phase in PA.

Henry's law thus reflects the fact that in order to reduce the molar fraction in the liquid phase of dissolved gases xₗ, it is possible to increase the Henrys constant and/or to reduce the total pressure of the fluid. Several methods exist which exploit the aforementioned phenomenon, among which are the methods described below are found.

A first type of known degassing method is the vacuum degassing. The degassing of a fluid can be carried out thanks to a decrease in pressure in a sealed vessel containing the fluid to be degassed. This method is based on the lowering of the partial pressure of the gases in a gas phase present in the vessel. This decrease in partial pressure generates a decrease in the molar fraction of gases in the gas phase. Through Henry's law, it appears that, at the gas-liquid interface, a disequilibrium is created which generates the transfer of the dissolved gases from the liquid phase to the gas phase. For example, the document U.S. Pat. No. 6,119,484 (a) relates to a molten glass degassing device by vacuum degassing. The main drawback of this type of method is that it is generally carried out discontinuously.

A second used type of degassing methods is the degassing by boiling the fluid. In general, the solubility of the gases dissolved in a liquid phase decreases with the temperature. This method is based on the fact that the solubility of a gas dissolved in the liquid phase decreases with a rise in temperature to reach its minimum value when the Henry's constant of the gas is maximum. The degassing of water used in electricity generation plants in contact with steam turbines, the degassing of a fluid in a heat pipe described by the document CN 1510386 (A) or the degassing of cooling fluid described in the document U.S. Pat. No. 3,789,577 (A) may be mentioned as example. The main drawbacks of this type of method is that it imposes a significant rise in the temperature of the fluid. This rise in temperature can cause the degradation of compounds present in the fluid, or even the degradation of the fluid itself. For example, undesirable chemical reactions can occur in the gas and/or liquid phase, such as an oxidation of a compound dissolved in the liquid phase, a self-decomposition of the compounds in the gas phase.

There is another type of degassing methods exploiting the aforementioned phenomenon, which is characterised by a step in which the fluid is treated by cavitation. More particularly, the fluid is subjected to a depression such that the pressure of the fluid becomes lower than its saturation vapour pressure. Therefore, vapour bubbles are likely to be generated and to form a gas phase, towards which a transfer of the dissolved gases from the liquid phase can be subsequently performed, commonly referred to as the desorption phenomenon.

It is in particular known from the document Z. Yang et al., A prototype of ultrasonic micro-degassing device for portable dialysis system, Sensors and Actuators A: Physical, 95, 274-280, 2002, a microfluidic device for degassing a fluid by acoustic cavitation. The fluid to be degassed is subjected to an acoustic wave, herein ultrasound, in order to allow its cavitation. For this, the degassing device comprises a degassing chamber and a piezo-transducer module for the emission of ultrasound. The acoustic cavitation and the elimination of gas bubbles are carried out in the degassing chamber. The elimination of gas bubbles is carried out by hydrophobic channels distributed all along the degassing chamber. However, the use of ultrasound can induce an uncontrolled rise in fluid temperature. Herein again, this rise in temperature can cause the degradation of compounds present in the fluid, or even the degradation of the fluid itself.

It is further known from the document U.S. Pat. No. 3,853,500 (A), a method for degassing viscous fluids. This method comprises a step in which the fluid is passed through a perforated partition to degas it and form bubbles therein and a subsequent step in which the fluid is agitated by subjecting it to ultrasound. Herein again, the use of ultrasound can induce an uncontrolled rise in the temperature of the fluid.

An object of the present invention is therefore to propose a method for degassing by cavitation allowing improving the degassing of a fluid. Another object of the invention may be to increase the efficiency of the degassing method by cavitation of a fluid. Another object of the invention may be to improve the elimination by cavitation of at least one gas dissolved in a fluid while limiting the risk of degradation of compounds possibly present in the fluid, or even the risk of degradation of the fluid itself, during degassing. More particularly, an object of the invention is to limit the rise in temperature of the fluid during the method so as to avoid the degradation of compounds possibly present in the fluid, or even the degradation of the fluid itself.

The other objects, features and advantages of the present invention will become apparent from examining the following description and the accompanying drawings. It is understood that other advantages may be incorporated.

### SUMMARY

In order to achieve this objective, according to one embodiment, a method for degassing a fluid is provided, comprising the following steps:
supplying, at the inlet of a reactor, a fluid which can comprise at least one dissolved gas; then
causing the fluid to flow through the reactor, the reactor comprising at least one fluid conduit, the at least one fluid conduit comprising a first portion, a second portion and a third portion, the second portion being disposed between the first portion and the third portion, the second portion having a reduced hydraulic diameter relative to the first portion and the third portion, and the flow being set such that bubbles are generated by cavitation, the fluid then comprising a liquid phase and a gas phase, then
allowing the at least partial transfer of the at least one dissolved gas present, or even remaining, in the liquid phase to the gas phase;
separating the liquid phase and the gas phase;
recovering the liquid phase to obtain the degassed fluid,

Advantageously, the method not involving the application of ultrasound to the fluid between the step in which the fluid is supplied at the inlet of the reactor and the step of separating the liquid phase and the gas phase.

Thus, the method implements a degassing of a fluid by hydrodynamic cavitation. By hydrodynamic cavitation, the degassing is performed by applying a continuous pressure lowering in the fluid, during its flow through the at least one reactor. Therefore, the degassing method can be implemented continuously.

Furthermore, the method not involving the application of ultrasound to the fluid, the method allows limiting, or even avoiding, an uncontrolled rise in the temperature of the fluid. Thus, the fluid can be substantially at ambient temperature, for example to avoid the degradation of compounds dissolved in the fluid, or even the degradation of the fluid itself. The fluid may further be at a controlled temperature.

Preferably, the liquid phase and the gas phase are separated at the outlet of the reactor.

Optionally, the method may further have at least any one of the following features, possibly used in combination or alternatively.

The at least one fluid conduit may be a microfluidic conduit. The use of a microfluidic conduit allows inducing the micro-cavitation of the fluid. Because of this small hydraulic diameter, a dense dispersion of bubbles of millimetre or even micrometre size can be created. These bubbles are then characterised by an interfacial area per unit volume which can be greater than 3000 m⁻¹. The phase transfer of the dissolved gases is thus facilitated, increasing the efficiency of the degassing method. Preferably, the reduced hydraulic diameter is less than 1 mm, preferably than 800 μm, preferably less than 300 μm, preferably less than 150 μm, even more preferably less than 100 μm.

The liquid phase and the gas phase can be separated at the outlet of the reactor, the third portion having a length selected to temporally dissociate the generation of bubbles by cavitation and the separation of the liquid phase and the gas phase. The method thus allows the fluid to flow through the third portion so as to promote the phase transfer of the dissolved gases.

The first portion, the second portion and the third portion are preferably added.

The at least one conduit of the reactor may comprise at least one of a diaphragm, or even a micro-diaphragm, a Venturi, or even a micro-Venturi and a step, or even a micro-step. The step may further have a protruding edge.

The second portion may have a section transverse to a longitudinal axis of the conduit, of an aspect ratio greater than or equal to 3. Alternatively or additionally, the first portion may have a transverse section of area A1, and the second portion may have a transverse section of area A2, the transverse sections being perpendicular to a longitudinal axis (x) of the conduit, the ratio A1/A2 is greater than or equal to 3.

The fluid may have a viscosity less than 5 mPa·s (10⁻³ mPa·s) at the method implementation temperature, preferably the viscosity of the fluid being comprised between 0.5 mPa·s and 5 mPa·s at the temperature of 20° C.

The flow of the fluid through the at least one reactor can be configured so as to be turbulent at least downstream of the second portion. A turbulent regime allows promoting the mixture of dissolved gases in the liquid phase. According to one example, the fluid flow velocity in at least one reactor, is set such that the flow is turbulent at least downstream of the second portion. The turbulent regime is reached when the Reynolds number of the flow is greater than 2300, the Reynolds number being defined as:

$$Re = \frac{ρ UD}{μ}$$

with U the fluid flow velocity (in m·s⁻¹), D the hydraulic diameter (in m), p the density of the liquid (in kg·m⁻³), and p its viscosity. (in Pa·s). Thus the diffusion of dissolved gases from the liquid phase to the liquid-gas interface, at the surface of the bubbles, is accelerated. The efficiency of the degassing method is thus further increased. Furthermore, the total interfacial area per unit volume of the generated bubbles is thus very large, which, in synergy with the turbulent nature of the fluid flow, allows intensifying the transfer of the dissolved gases and contributes to improving the efficiency of the method.

When the fluid flows through the third portion, the fluid may be at a pressure lower than the pressure of the fluid in the first portion, and for example lower than the ambient pressure. Preferably, said pressure is lower than the saturation pressure of the at least one dissolved gas, at the temperature of the fluid at the inlet of the reactor.

When the fluid flows through the third portion, the pressure in the third portion is preferably lower than the ambient pressure, by substantially 1 bar.

When the fluid flows through the third portion, or even until the liquid phase and the gas phase are separated from each other, the fluid can be at a temperature comprised between the ambient temperature and the boiling temperature of the fluid.

The fluid can be at a temperature comprised between the solidification temperature of the fluid, for example 0° C. for water at 1 bar, and the boiling temperature thereof, for example 100° C. for water at 1 bar.

When the fluid flows through the third portion, or even until the liquid phase and the gas phase are separated from each other, the fluid can be at a temperature selected so as to maximise the Henrys constant of the at least one dissolved gas. When the fluid flows through the third portion, even until the liquid phase and the gas phase are separated from each other, the fluid is at a temperature selected so as to minimise the solubility of the at least one dissolved gas.

When the fluid flows through the third portion, even until the liquid phase and the gas phase are separated from each other, the fluid comprising a plurality of dissolved gases, the temperature can be selected so as to maximise the Henry's constant of a gas from the plurality of dissolved gases, in order to allow a selectivity of the degassing relative to a particular dissolved gas.

When the fluid flows through the third portion, or even through the reactor, or even until the liquid phase and the gas phase are separated from each other, the fluid comprising a plurality of dissolved gases, the fluid can be at a temperature selected so as to promote the degassing of a gas from the plurality of dissolved gases, and in particular the at least partial transfer of the at least one dissolved gas.

The temperature of the fluid can be controlled by a heating device.

Moreover, the reactor can comprise a plurality of conduits. Preferably the conduits are arranged in parallel.

### BRIEF DESCRIPTION OF FIGURES

The aims, objects, as well as the features and advantages of the invention will emerge better from the detailed description of one embodiment thereof which is illustrated by the following accompanying drawings in which:

FIG. 1 represents the steps of the degassing method according to one embodiment of the invention.

FIG. 2 represents a diagram of the experimental setup of the degassing method according to one embodiment of the invention.

FIG. 3 represents the evolution of the hydraulic diameter D of the portions of the conduit during the flow of the fluid, according to one embodiment of the invention.

FIG. 4 represents the evolution of the fluid flow velocity F during the flow of the fluid, according to the embodiment illustrated in FIG. 3.

FIG. 5 represents the evolution of the pressure P during the flow of the fluid, according to the embodiment illustrated in FIG. 3.

FIG. 6 represents the evolution of the volume fraction a of the gas phase during the flow of the fluid, according to the embodiment illustrated in FIG. 3.

FIG. 7 represents a conduit of the reactor according to one embodiment of the invention.

FIG. 8 represents a conduit of the reactor according to another embodiment of the invention.

FIG. 9 represents a conduit of the reactor according to another embodiment of the invention.

FIG. 10 represents examples of flow (from right to left) observed in the degassing method according to one embodiment of the invention, the conduit comprising a micro-step.

FIG. 11 represents an example of flow (from right to left) observed in the degassing method according to one embodiment of the invention, the conduit comprising a micro-diaphragm.

The drawings are given by way of examples and are not limiting to the invention. They constitute schematic representations of principle intended to facilitate understanding of the invention and are not necessarily scaled to practical applications.

### DETAILED DESCRIPTION

It is specified that within the scope of the present invention, the term “degassing” designates the at least partial extraction of the gases dissolved in a fluid, also known as desorption. Equivalently, the degassing consists in reducing the concentration of gases dissolved in a liquid phase. Thus, in the context of the present invention, a distinction is made between degassing of a debubbling or else deaeration, which consists in eliminating bubbles initially present in a liquid phase by a simple mechanical separation of a gas phase and a liquid phase. The degassing performed during the implementation of the method can however be accompanied by a debubbling.

The term “gas” means a group formed by compounds in the gaseous state under ambient conditions of temperature and pressure, and volatile organic compounds. By way of non-limiting example, these gases can include dioxygen, dinitrogen, carbon dioxide, carbon monoxide, argon, nitrous oxide and methane.

These gases can be qualified as “non-condensable”, that is to say that, under the operating conditions of the method, they do not undergo a change in phase from the gaseous state to the liquid state and conversely. These gases are dissolved in a fluid and can undergo a transfer from a liquid phase in which they are dissolved to a gas phase.

The fluid can be qualified as “condensable”, that is to say that, under the operating conditions of the method, it can at least partially undergo a phase change from the gaseous state, which can also be signed as vapour, to the liquid state and conversely. For example, the condensable is water which can be in the form of liquid or vapour.

The term “viscosity” means the dynamic viscosity of the fluid in Pa·S.

The pressure is given in bar, corresponding to 1000 hPa in the international units system.

The “hydraulic diameter” D is commonly used to calculate flows through a conduit of section transverse to the longitudinal axis x of the conduit, the transverse section being of any shape. It can be determined according to the following relationship.

$$D = \frac{4 A}{{P}_{W}}$$

A being the area of the transverse section with the longitudinal axis x of the conduit, and Pw being the wet perimeter of this section (for «wetted perimeter»).

The term “micro-” geometry, means, in a known and current manner in the field of microfluidics, a geometry having at least one dimension substantially less than 1 mm.

The longitudinal axis of the fluid conduit can be defined locally as being the direction of main flow of the fluid through the conduit. Thus, the longitudinal axis of the fluid conduit is not necessarily a straight line, but can accommodate a curvature of the fluid conduit.

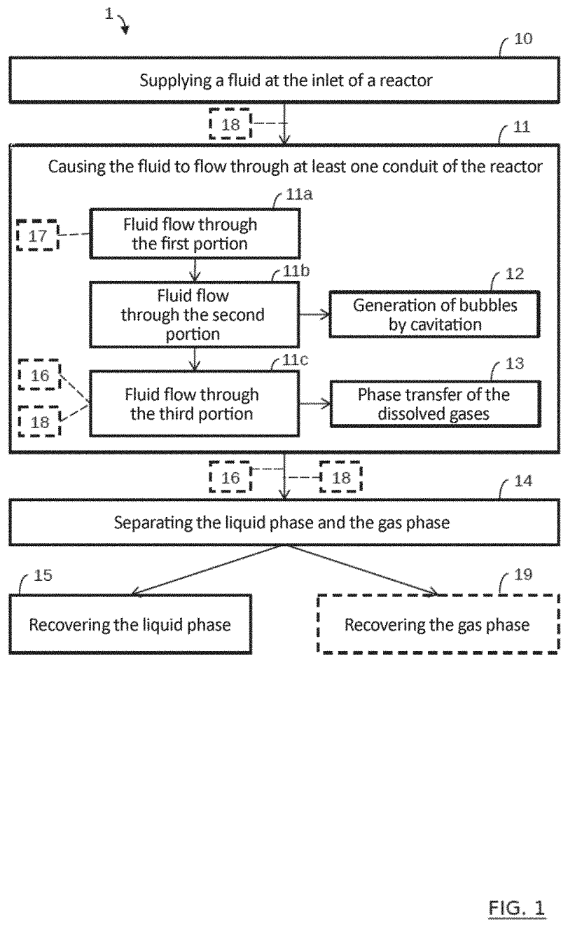

A particular embodiment of the degassing method 1 is now described. By way of example, the method 1 is illustrated in FIG. 1, where variants of the method 1 are indicated by paths in parallel and optional steps are indicated in dotted lines. By way of example, the elements of the experimental setup of the degassing method are illustrated in FIG. 2.

The fluid to be degassed is supplied 10 at the input of a reactor 2. It is specified that the fluid can comprise a gas phase G mixed with a liquid phase L, or a liquid phase L only, when it is provided 10 at the inlet of the reactor 2. Indeed, the gas phase allowing the desorption of the dissolved gases being generated by cavitation, it is not necessary that the fluid comprises a gas phase during its introduction into the reactor 2. In the following, and as illustrated in FIG. 2, the embodiment of the method, in which the fluid initially comprises only a liquid phase, is described. It is understood that the described features can also apply to a fluid initially comprising a gas phase G mixed with a liquid phase L. The fluid is likely to comprise at least one dissolved gas, that is to say that the solution can initially comprise at least one dissolved gas, the liquid phase concentration of which is desired to be minimised.

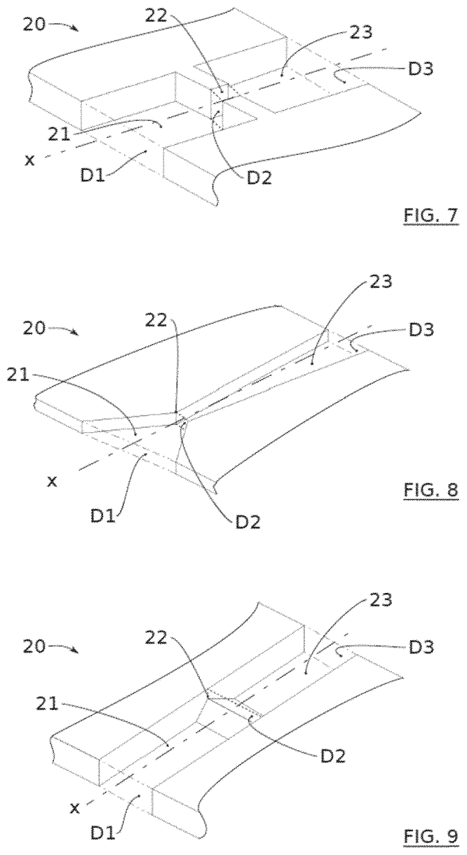

The reactor 2 includes at least one conduit 20, this conduit 20 comprising a first portion 21 of a hydraulic diameter D1, a second portion 22 of a hydraulic diameter D2, and a third portion 23 of a hydraulic diameter D3, as illustrated in FIGS. 7 and 8. The second portion 22 has more particularly a reduced hydraulic diameter D2 relative to those of the first portion 21 and the third portion 23.

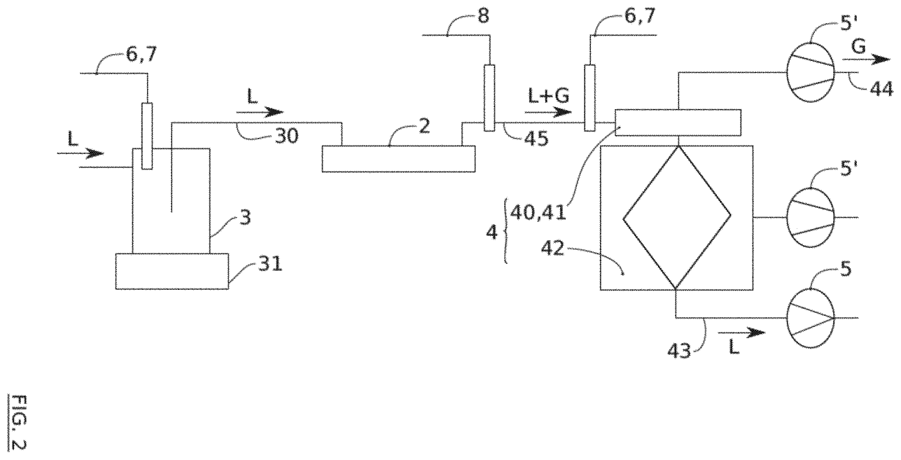

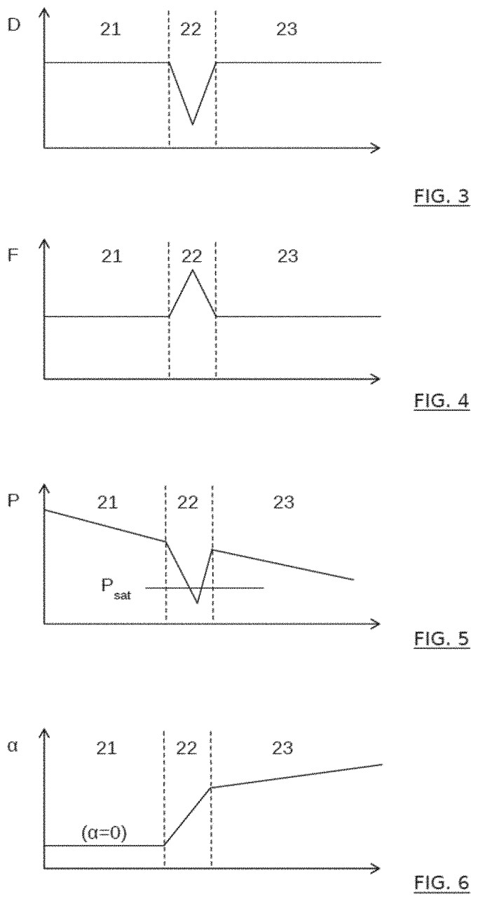

The reduction in the hydraulic diameter D2 of the second portion 22 allows the local lowering of the pressure during the flow 11 of the fluid through the reactor 2, to lead to the cavitation of the fluid. This phenomenon is explained with reference to FIGS. 3 to 6. The hydraulic diameter D decreases at the second portion 22 of the reactor 2, relative to the hydraulic diameters of the first portion 21 and the second portion 23, as illustrated in FIG. 3. The decrease in the hydraulic diameter D drives an increase in the velocity of the fluid, as illustrated in FIG. 4. Thus, the velocity F of the fluid increases during the flow 11b of the fluid through the second portion 22. This increase in the velocity F of the fluid induces a decrease in the static pressure P of the fluid, which can reach pressures equal to or even lower than the saturation pressure of the liquid Pₛₐₜ, as illustrated in FIG. 5. For example, Pₛₐₜ is equal to 23 Mbar for water at ambient temperature. It should be noted that, if the reduction in the hydraulic diameter D2 of the second portion 22 induces a singular pressure loss when the fluid flows 11b through the second portion 22, the pressure decreases by linear pressure losses during the flow 11a, 11c of the fluid through the first portion 21 and through the third portion 23.

The decrease in the static pressure with the reduction of the hydraulic diameter depends on many parameters such as the viscosity of the fluid, its flow velocity, the dimensions of the hydraulic diameter and the amplitude of the reduction in the hydraulic diameter, these parameters being able to be combined therebetween in many ways to lead to the cavitation. It is clear that the person skilled in the art will be able to adapt one or the other of these parameters to induce a cavitation of the fluid.

In a perfectly common manner, in the field of fluidics of microfluidics, the person skilled in the art knows how to adapt the different parameters of a fluid and a conduit in which the fluid circulates in order to generate a cavitation. The cavitation is obtained by adapting these different parameters such that the number of cavitation is less than 1 (σ<1). The number of cavitation σ can be defined as the ratio between the pressure lowering inducing the cavitation on the pressure drop generated by the flow, according to the following mathematical formula, with ρ the density of the fluid and U the velocity of the fluid in the second portion 22.

$$σ = \frac{P 3 - {P}_{sαt}}{0 , 5 ρ {U}^{2}}$$

These different parameters are for example taken from the flow velocity, the geometry of the conduit, and in particular the decrease in the surfaces of the transversal sections of the portions of the conduit in a direction substantially perpendicular to the flow. The cavitation can be detected by various techniques, for example by identifying the presence of bubbles. This presence of bubbles can for example be identified using an optical bubble sensor and/or using a camera and/or a binocular and/or a microscope.

When the static pressure of the fluid becomes less than the saturation pressure of the liquid Pₛₐₜ under the conditions of implementation of the method 1, a phase change of the fluid is induced. At least one portion of the liquid phase L of the fluid passes to the vapour state by generation 12 of bubbles by cavitation. According to the temperature and pressure conditions, these bubbles can further be assembled in a cavitation pocket.

FIG. 6 illustrates the evolution of the volume fraction a of the gas phase G when the fluid flows 11 through the reactor 2. The volume fraction a of the gas phase G can initially be substantially zero, the fluid initially comprising only a liquid phase, according to the illustrated example. When the fluid flows 11b through the second portion 22, the cavitation induces an increase in the volume fraction of the gas phase G. When the fluid flows 11c through the third portion 23, the volume fraction of the gas phase G can continue to increase due to linear pressure losses, or even due to the imposition of a low pressure downstream of the second portion 22.

During the generation 12 of the bubbles by cavitation, the gas phase mainly includes the fluid in its vapour form. The liquid-vapour equilibrium can be translated by the Raoult's law which links the molar fraction of the gas phase of the fluid x_{G(fluid)} to the molar fraction in the liquid phase of the fluid x_{L(fluid)} (generally substantially equal to 1) such that:

$$\frac{{x}_{g ( fluid )}}{{x}_{l ( fluid )}} \approx {x}_{g ( fluid )} = \frac{{P}_{sat}}{P}$$

With Pₛₐₜ the saturation vapour pressure of the fluid in Pa and P the pressure in the gas phase in Pa.

The appearance of these bubbles or pockets initially filled with steam induces a phase transfer 13 of the gases dissolved in the liquid phase to the gas phase, this transfer capable of being translated by Henry's law for a non-condensable gas i.

$$\frac{{x}_{g ( i )}}{{x}_{l ( i )}} = \frac{{H}_{i}}{P}$$

With x_{g(i)} the molar fraction of the gas i in the gas phase, xₗ₍ᵢ₎ the molar fraction of the gas i dissolves in the liquid phase, H the Henrys constant of the gas i, in Pa, and P the pressure in the gas phase in Pa.

This transfer 13 of the non-condensable gases comprises more particularly the diffusion of the non-condensable gases at the liquid-gas interface, from the liquid phase to the gas phase. Thus the gas phase G can be loaded with non-condensable gas initially dissolved in the liquid phase of the fluid to be degassed.

At the outlet of the reactor, the fluid comprises a liquid phase L and a gas phase G. The gas phase G has a proportion of non-condensable gas initially dissolved in the fluid to be degassed, more or less significant depending on the efficiency of the degassing.

The liquid phase L and the gas phase G are then separated 14. For this, a separation device 4, as shown schematically in FIG. 2, can be used. For example, the separation device 4 can comprise a membrane 41, permeable to gases, in an enclosure 40 and a tank 42. According to this example, the fluid, comprising the liquid phase L and the gas phase G, can be supplied in the first gas/liquid separation enclosure 40. The gas phase G can pass through the permeable membrane 41 to be discharged through the conduit 44. Alternatively, any method for separating a gas phase G and a liquid phase L can be considered.

The liquid phase and the gas phase can be separated directly at the outlet of reactor 2. Alternatively, a connection conduit 45 can connect the reactor 2 to the separation chamber 4.

After the separation 14 of the liquid phase L and the gas phase G, the degassed liquid phase is recovered 15. For this, the separation device 4 can for example comprise a tank 42 comprising a membrane which is not permeable to gases defining a volume configured to accommodate the liquid phase L. the tank 42 can be connected to a gas pump 5′ communicating with the outside of this volume in order to maintain the tank 42 under vacuum. The tank 42, and more particularly the volume configured to receive the liquid phase L, can be connected to a conduit 43 for discharging the liquid phase, connected to the tank 42, the conduit 43 being able to comprise a pump 5 allowing pumping out the degassed fluid in the liquid state. Furthermore, the gas phase G can be recovered 19. For this, the separation device 4 can further comprise a conduit 44 for discharging the gas phase, which is connected to the first enclosure 40, the conduit 44 possibly comprising a gas pump 5′.

The method 1 not involving the application of ultrasound to the fluid, at least between the step in which the fluid is supplied 10 to the reactor 2 and the step 14 of separating the liquid phase L and the gas phase G. The method thus allows degassing a fluid while avoiding an uncontrolled increase in its temperature. The fluid may comprise compounds, other than non-condensable gases, which may be altered or even degrade above a certain temperature. For example, the fluid can include biomolecules such as proteins, carbohydrates or lipids. Advantageously, a fluid comprising these compounds can thus be degassed, while avoiding their alteration, or even their degradation.

In the method 1, the degassing of the fluid being performed by applying a continuous pressure lowering thereto it during its flow 11 through the reactor 2, the degassing of the fluid can be performed continuously. It is understood that the fluid can be supplied 10 continuously to the reactor 2. The fluid can be supplied 10 directly to the reactor 2. According to the example used in FIG. 2, the fluid can be supplied 10 to the reactor by a tank 3, this tank 3 being capable of being connected to the reactor 2 by a connection conduit 30. The tank can further comprise a device 31 for measuring the mass flow rate of the fluid.

An example of reactor 2 is described with reference to FIGS. 7 to 9. According to this example, the reactor comprises a conduit 20 as described above. The first portion 21 may have a hydraulic diameter D1, and the third portion may have a hydraulic diameter D3. At least one of the first portion 21 and the second portion 23 may have a constant hydraulic diameter along the longitudinal axis of the conduit 20. The conduit 20 may more particularly comprise a diaphragm, or even a micro-diaphragm, as illustrated in FIGS. 7 and 11.

At least one of the first portion 21 and the second portion 23 may have a variable hydraulic diameter along the longitudinal axis of the conduit 20. According to one example, at least one of the hydraulic diameter D1 of the first portion 21 and the hydraulic diameter D3 of the third portion can vary monotonously along the longitudinal axis of the conduit 20. According to this example, the second portion 22 can be of a specific length along the longitudinal axis of the conduit 20. The conduit 20 may more particularly comprise a Venturi, or Venturi tube, or even a micro-Venturi, as illustrated in FIG. 8.

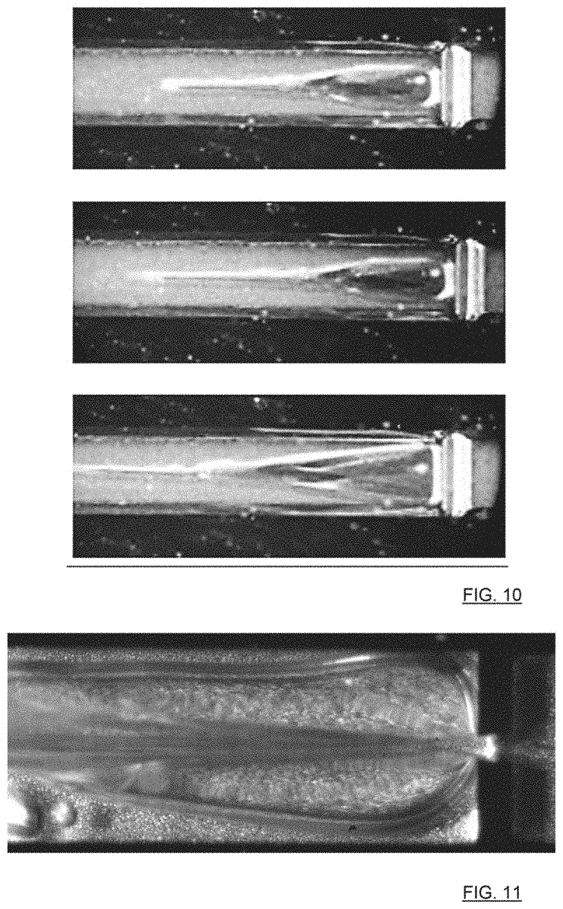

At least one of the first portion 21 and the second portion 23 may have a variable hydraulic diameter which is variable over one part of the portion, along the longitudinal axis of the conduit 20, as the example illustrated in FIG. 9. According to this example, the second portion 22 can be of a specific length along the longitudinal axis of the conduit 20. The conduit 20 can more particularly comprise a step, or even a micro-step as illustrated in FIG. 10. The step can further have a protruding edge so as to improve the cavitation of the fluid.

It should be noted that any geometry of the conduit 20 allowing the cavitation of the fluid can be considered. Any negative pressure geometry, configured to induce the cavitation of the fluid, can more particularly be considered.

The efficiency of the degassing by the method 1 can be optimised such that a proportion of non-condensable gases in the gas phase G is as significant as possible. Several solutions are possible and can be used in a complementary or alternative manner. These solutions are detailed below.

The reactor can be a microfluidic reactor. The use of a microfluidic conduit allows inducing the micro-cavitation of the fluid. The micro-cavitation can result in the generation 12 of a dense dispersion of bubbles with a size which is substantially less than 1 mm, or even significantly less than 100 μm. The micro-cavitation therefore differs from the most common cavitation carried out on a macro-scale, that is to say on a scale of at least one centimetre. These bubbles are then characterised by a very large interfacial surface per unit volume, in a very limited liquid volume. For example, the interfacial surface per unit volume of the bubbles can be greater than 1000 m⁻¹ for a fluid volume less than 0.55 mm³. This dense dispersion of bubbles can form a cavitation pocket, of micrometric dimension in a direction substantially perpendicular to the direction of the flow, and micrometric to millimetric in a direction substantially parallel to the direction of flow. At least one of the first portion 21, the second portion 22 and the third portion 23 has at least one dimension of the section thereof transverse to the longitudinal axis of the conduit 20, which is less than 1 mm, or even less than 500 μm. Preferably, the entire conduit 20 has at least one dimension of the section thereof transverse to its longitudinal axis, which is less than 1 mm, or even less than 500 μm. The reduced hydraulic diameter D2 can more particularly be substantially less than 1 mm, preferably less than 800 μm, preferably less than 300 μm, preferably less than 150 μm, even more preferably less than 90 μm. The more the hydraulic diameter is reduced, the more the interfacial surface of the bubbles per unit volume is increased and the more the phenomenon of micro-cavitation is improved.

The second portion 22 may have a section transverse to the longitudinal axis x of the conduit, with an aspect ratio greater than or equal to 3. In a known and common manner in the field, the aspect ratio, also referred to as shape ratio, designates the ratio between the longest dimension and the shortest dimension of the transverse section, for example between one of its length and its width, and the other of its length and its width. According to an alternative or complementary example, the second portion 22 may have a transverse section of area A1, substantially perpendicular to the longitudinal axis x of the conduit, and the first portion 21 may have a transverse section of area A2, substantially perpendicular to the longitudinal axis x of the conduit, such that the fluid passage surface ratio A1/A2 is substantially greater than or equal to 3. An aspect ratio greater than or equal to 3, and/or a passage surface ratio of the fluid greater than or equal to 3, allows confining the fluid along at least one dimension, relative to the dimensions of the cross section of the first portion 21. This confinement allows increasing the fluid flow velocity 11b at the second portion 22. The increase in the fluid flow velocity allows lowering the local pressure and thus generating the cavitation, and preferably reaching a turbulent flow regime. Furthermore, the reactor 2 can thus comprise a plurality of conduits 20, for example disposed in parallel, while remaining of limited volume.

The reactor 2 may indeed comprise a plurality of conduits 20 disposed in parallel. A larger quantity of fluid can thus be degassed in parallel. For example, each of the conduits 20 can open into the same separation chamber 4. Each of the conduits 20 can be connected to the same tank 3.

The fluid flow 11c may be turbulent downstream of the second portion 22, and in particular in the third portion 23. The flow may in particular have a Reynolds number greater than 2300. A turbulent flow allows, on the one hand, promote a stirring of the liquid phase of the fluid, and in particular promoting the mixture of the bubbles and the dissolved species, such as non-condensable gases, in the liquid phase of the fluid. Thus, the diffusion of dissolved gases from the liquid phase to the liquid-gas interface, on the surface of the bubbles formed 12 by cavitation, can be accelerated. Furthermore, a turbulent flow allows avoiding the presence of dead volume in the reactor 2. As is clear from the preceding description, the fluid flow velocity can be set so that the flow of the fluid is turbulent, having a Reynolds number greater than 2300, downstream of the second portion 22.

Furthermore, the turbulent flow of the fluid, in synergy with the use of a microfluidic conduit 20 and therefore the generation 12 of a dispersion of bubbles with a high interfacial area, allows the intensification of the phase transfer 13 of the dissolved gases. Thus the proportion in the gas phase of non-condensable gases can more quickly reach its equilibrium value given by Henry's law.

Moreover, so that the proportion in the gas phase of the non-condensable gases can reach its equilibrium value according to Henry's law under the temperature and pressure conditions of the method, the third portion 23, or the third portion 23 plus a connection conduit 45 connecting the reactor 2 to the separation chamber 4, may have a length selected to temporarily dissociate the generation 12 of the bubbles by cavitation and the separation 14 of the liquid phase L and the gas phase G.

This temporal dissociation allows promoting the establishment of the mass transfer equilibrium. Since the bubbles initially mainly comprise the fluid in its vapour form, the molar fraction of the non-condensable gases in the gas phase can thus be controlled, or even increased before the step of separating the liquid phase L and the gas phase G. Furthermore, additional pressure losses can be induced during the flow 11c of the fluid through the third portion 23, the longer the third portion 23 is.

In order to optimise the efficiency of the degassing by the method 1, the pressure and temperature of the experimental setup can be adjusted. The pressure P3 downstream of the second portion 22, and until the separation 14 of the liquid phase L and the gas phase G, can be selected 16 so as to avoid a redissolution of the gases in the liquid phase L. Furthermore, maintaining 16 a low pressure P3 downstream induces additional pressure losses of the fluid during its flow 11c through the third portion 23 and therefore promotes the creation of a larger gas phase G.

The pressure P2 in the second portion 22 and the pressure P3 downstream of the second portion 22, and in particular in the third portion 23, are preferably lower than the saturation vapour pressure (Pₛₐₜ) of the fluid at the temperature of the fluid at the inlet of the reactor.

According to Henrys law, the equilibrium proportion of non-condensable gases in the gas phase G depends in part on the pressure conditions applied to the fluid. Maintaining 16 a low pressure P3 of the fluid downstream of the second portion 22 allows promoting the phase transfer of the non-condensable gases. During the development of the method 1, the tests have shown that the lower the pressure P3 downstream of the second portion 22, the more effective the degassing. In particular, a concentration of gases dissolved in the degassed liquid phase of less than 1 mg/L can be achieved. The concentration of gases dissolved in the degassed liquid phase can be measured by gas concentration probes 7, disposed upstream and/or downstream of the reactor 2. More particularly the pressure P3 downstream of the second portion 22 can be lower than the ambient pressure, by substantially 1 bar.

The flow rate and the pressure P3 in the third portion 23 can be adjusted in order to generate a flow having a cavitation number a of less than 1 or even the lowest possible in order to optimise the degassing. The cavitation number σ is herein defined as the ratio between the pressure lowering inducing the cavitation on the pressure drop generated by the flow, according to the following mathematical formula, with ρ the density of the fluid and U the velocity of the fluid in the second portion 22.

$$σ = \frac{P 3 - {P}_{sat}}{0 , 5 ρ {U}^{2}}$$

The pressure P3 downstream of the second portion 22 can be controlled 16 by a vacuum pump 5 connected to the separation chamber 4. The vacuum force of the applied by the vacuum pump 5 can for example be regulated depending on the measurement of the pressure P3 by a pressure sensor 8 disposed downstream of the second portion 2, or even downstream of the reactor 2, as illustrated in FIG. 2.

According to Henrys law, the equilibrium proportion of the non-condensable gases in the gas phase G depends, on the other hand, on the temperature conditions applied to the fluid. The fluid can be 18 at a temperature comprised between the solidification temperature and the boiling temperature of the fluid. Preferably, the fluid is maintained 18 at a temperature within this range. The control of the temperature allows promoting the flow 11 of the fluid through the reactor 2 and to promote the transfer of the dissolved gases. In this temperature range, the higher the temperature, the more the viscosity of the fluid can be reduced. By controlling the temperature, the method allows a compromise between promoting the transfer of dissolved gases, and limiting the risk of degrading compounds optionally present in the fluid, or even the fluid itself. Preferably, when the fluid is water, the fluid can be maintained at a temperature comprised between 0 and 100° C.

The closer the temperature downstream of the second portion 22 is to that corresponding to the lowest dissolved gas solubility, that is to say a high Henry's constant, the more effective the degassing. When the fluid flows 11 through the third portion 23, even until the liquid phase L and the gas phase G are separated 15, the fluid can be at a temperature selected so as to maximise Henrys constant, or equivalently so as to minimise the solubility of dissolved gases in the liquid phase.

The temperature of the fluid can be controlled 18 by a heating device, preferably allowing the reactor 2, or even the entire experimental setup, to be maintained at the desired temperature. For example, a heat exchanger or a thermostated enclosure can be used. Temperature sensors 6 can further be disposed upstream and downstream of the reactor 2 in order to measure the temperature of the fluid, as illustrated in FIG. 2.

In order to optimise the efficiency of the degassing by the method 1, the fluid may also have a viscosity of less than 5 mPa·s (10⁻³ Pa·s) at the method implementation temperature. The fluid may more particularly have a viscosity of less than 2 mPa·s when the fluid is at the temperature of 20° C. Thus, the fluid can be sufficiently low in viscosity to facilitate its flow through the reactor 2, and thus facilitate its cavitation. When the conduit is a microfluidic conduit, the viscosity of the fluid can preferably be comprised between 0.5 mPa·s and 5 mPa·s at the method implementation temperature, and preferably between 0.5 mPa·s and 2 mPa·s, in order to facilitate its flow through this conduit. The fluid may more particularly be water.

According to the selection of the pressures applied to the fluid and the temperature of the fluid, the method can be configured to eliminate a gas in particular from a plurality of non-condensable gases. For this, the temperature of the fluid, at least downstream of the second portion 22 of the conduit 20, can be selected 18 as that corresponding to the lowest solubility of the targeted gas. Equivalently, this temperature can be selected 18 so as to maximise the Henry's constant of the targeted gas. The Henrys constant of a gas is generally maximum when the solubility of this gas is minimum. For example, Henry's constant of dioxygen, dinitrogen, carbon dioxide in water is maximum at a temperature substantially comprised between 100 and 130° C. Typically, a rise in temperature of the fluid promotes the degassing. For example, Henrys constant in water is maximum at T=100° C. for dioxygen O₂ and dinitrogen N₂ but not for CO₂ for which Henry's constant is maximum at T=130° C. Thus, if the fluid is water under cavitation at a temperature of substantially 130° C., the degassing carried out by the method will be more selective towards CO₂ than towards N₂ and O₂. A temperature close to 100° C. may be more appropriate to maximise the degassing of N₂ and O₂.

The temperature downstream of the second portion 22 can be selected so as to promote the diffusion in the liquid phase of a gas from the plurality of dissolved gases. Since the temperature influences the rate of diffusion of the gases in the liquid phase, a more or less rapid degassing of the different dissolved gases can thus be obtained. Thus the degassing of the fluid can be made more selective for a particular dissolved gas.

The invention is not limited to the previously described embodiments and extends to all embodiments covered by the claims.

For example, provision can be made for the method to include the successive flow of the fluid through a plurality of reactors, before the step 14 of separating the liquid phase G and the gas phase.

Provision can further be made for the at least one conduit to have a succession of geometries configured to generate bubbles in the fluid by cavitation. More particularly, each of these geometries can comprise the three portions described above, the third portion of one of these geometries acting for example as a first portion of the following configuration.

### LIST OF THE REFERENCE NUMERALS

1 Method
10 Supplying a fluid at the inlet of a reactor
11 Causing the fluid to flow through the reactor
11a Fluid flow through the first portion
11b Fluid flow through the second portion
11c Fluid flow through the third portion
12 Generation of the bubbles by cavitation
13 Phase transfer of the dissolved gases
14 Separating the liquid phase and the gas phase
15 Recovering the liquid phase
16 The fluid is under a pressure P3
17 The fluid is under a pressure P1
18 The fluid is at a temperature T
19 Recovering the gas phase
2 Reactor
20 Conduit
21 First portion
22 Second portion
23 Third portion
3 Tank
30 Connection conduit
31 Device for measuring the mass flow rate
4 Separation device
40 First enclosure
41 Permeable membrane
42 Tank
43 Conduit for discharging the liquid phase
44 Conduit for discharging the gas phase
45 Connection conduit
5 Pump
5′ Gas pump
6 Temperature sensor
7 Dissolved gas concentration probe
8 Pressure sensor
D1 Hydraulic diameter of the first portion
D2 Reduced hydraulic diameter
D3 Hydraulic diameter of the third portion
L Liquid phase
G Gas phase
P1 Pressure in the first portion
P2 Pressure in the second portion
P3 Pressure in the third portion

1. A method for degassing a fluid comprising:
supplying, at an inlet of a reactor, a fluid comprising at least one dissolved gas; then
causing the fluid to flow through the reactor, the reactor comprising at least one microfluidic conduit, the at least one microfluidic conduit comprising a first portion, a second portion and a third portion, the second portion being disposed between the first portion and the third portion, the second portion having a reduced hydraulic diameter relative to the first portion and the third portion, the reduced hydraulic diameter being less than 1 mm, and the flow is set such that bubbles are generated by micro-cavitation, the fluid then comprising a liquid phase and a gas phase, then
allowing at least one partial transfer of the at least one dissolved gas present in the liquid phase to the gas phase;
separating the liquid phase and the gas phase; and
recovering the liquid phase to obtain the degassed fluid,
the method not involving the application of ultrasound to the fluid between the step in which the fluid is supplied at the inlet of the reactor and the step of separating the liquid phase and the gas phase.

2. The method according to claim 1, wherein the reduced hydraulic diameter is less than 300 μm, preferably less than 150 μm, even more preferably less than 100 μm.

3. The method according to claim 1, wherein the liquid phase and the gas phase are separated at an outlet of the reactor, the third portion having a length selected to temporally dissociate the generation of bubbles by cavitation and the separation of the liquid phase and the gas phase.

4. The method according to claim 1, wherein at least one conduit comprises one of a diaphragm, or even a micro-diaphragm, a Venturi, or even a micro-Venturi and a step, or even a micro-step.

5. The method according to claim 1, wherein the second portion has a section transverse to a longitudinal axis of the at least one conduit, of an aspect ratio greater than or equal to 3.

6. The method according to claim 1, wherein the first portion has a transverse section of area A1, and the second portion has a transverse section of area A2, the transverse sections of area A1 and the transverse section of area A2 being perpendicular to a longitudinal axis (x) of the conduit, the ratio A1/A2 being greater than or equal to 3.

7. The method according to claim 1, wherein the fluid has a viscosity less than 5 mPa·s at a method implementation temperature, preferably the viscosity of the fluid being comprised between 0.5 mPa·s and 5 mPa·s at a temperature of 20° C.

8. The method according to claim 1, wherein a fluid flow velocity in at least one reactor is set such that the flow is turbulent at least downstream of the second portion.

9. The method according to claim 1, wherein, when the fluid flows through the third portion, the fluid is at a pressure less than a pressure of the fluid in the first portion.

10. The method according to claim 1, wherein the pressure in the third portion is less than a ambient pressure.

11. The method according to claim 1, wherein, when the fluid flows through the third portion, or even until the liquid phase and the gas phase are separated from each other, the fluid is at a temperature comprised between a fluid solidification temperature and a fluid boiling temperature, the fluid temperature being controlled by a heating device.

12. The method according to claim 1, wherein, when the fluid flows through the third portion, or even until the liquid phase and the gas phase are separated from each other, the fluid is at a temperature selected so as to maximise the Henry's constant of the at least one dissolved gas, the fluid temperature being controlled by a heating device.

13. The method according to claim 1, wherein, when the fluid flows through the third portion, or even until the liquid phase and the gas phase are separated from each other, the fluid comprising a plurality of dissolved gases, the fluid temperature is selected so as to maximise Henry's constant of a gas from the plurality of dissolved gases, the fluid temperature being controlled by a heating device.

14. The method according to claim 1, wherein, when the fluid flows through the third portion, or even through the reactor, or even until the liquid phase and the gas phase are separated from each other, the fluid comprising a plurality of dissolved gases, the fluid is at a temperature selected so as to promote the at least partial transfer of the at least one dissolved gas, the fluid temperature being controlled by a heating device.

15. The method according to claim 1, wherein the reactor comprises a plurality of conduits, preferably disposed in parallel.
